(19) United States
(12) Patent Application Publication
(10) Pub. No.: US 2014/0356664 A1
(43) Pub. Date: Dec. 4, 2014

(54) BATTERY MODULE

(71) Applicant: SAMSUNG SDI CO., LTD., Yongin-si (KR)

(72) Inventor: Hyun-Min JUNG, Yongin-si (KR)

(73) Assignee: SAMSUNG SDI CO., LTD., Yongin-si (KR)

(21) Appl. No.: 14/203,923

(22) Filed: Mar. 11, 2014

(30) Foreign Application Priority Data
May 30, 2013 (KR) 10-2013-0061631

(51) Int. Cl. H01M 2/10

(52) U.S. Cl. CPC H01M 2/1072; H01M 2220/20
USPC 429/82; 429/151

(57) ABSTRACT

A battery module includes a plurality of battery cells aligned in one direction, the plurality of battery cells being adjacent to each other along a first direction, a pair of side plates spaced apart from each other along a second direction perpendicular to the first direction, the plurality of aligned battery cells being positioned between the pair of side plates, and barriers respectively interposed among the plurality of battery cells, each barrier including at least one first fixing portion on a side thereof, the at least one first fixing portion being coupled to a corresponding second fixing portion on a side plate of the pair of side plates.

### CROSS-REFERENCE TO RELATED APPLICATION

Korean Patent Application No. 10-2013-0061631, filed on May 30, 2013, in the Korean Intellectual Property Office, and entitled: “Battery Module,” is incorporated by reference herein in its entirety.

### BACKGROUND

1. Field

Example embodiments relate to a battery module having improved impact resistance.

2. Description of the Related Art

A high-power battery module using a non-aqueous electrolyte with high energy density has recently been developed. The high-power battery module is configured as a large-capacity battery module manufactured by connecting a plurality of battery cells in series so as to be used in driving motors of devices requiring high power, e.g., electric vehicles and the like. The battery module may include a plurality of battery cells, in consideration of output voltage and current.

### SUMMARY

Embodiments provide a battery module having improved impact resistance so that battery cells constituting the battery module can be firmly fixed, regardless of external impact, vibration, etc. in any direction.

According to example embodiments, there is provided a battery module including a plurality of battery cells aligned in one direction, the plurality of battery cells being adjacent to each other along a first direction, a pair of side plates spaced apart from each other along a second direction perpendicular to the first direction, the plurality of aligned battery cells being positioned between the pair of side plates, and barriers respectively interposed among the plurality of battery cells, each barrier including at least one first fixing portion on a side thereof, the at least one first fixing portion being coupled to a corresponding second fixing portion on a side plate of the pair of side plates.

The first fixing portion may include a protrusion extending toward the side plate.

The first fixing portion may have a convex shape extending toward the side plate.

The second fixing portion may have a concave shape extending away from the barrier, the first fixing portion being accommodated in the concave shape of the second fixing portion.

The first fixing portion may have a “π” shape.

The second fixing portion may be between openings in the side plate, a width of the second fixing portion being equal to a distance between the openings and being accommodated in the π-shaped first fixing portion.

A longitudinal direction of the first fixing portion may be perpendicular to the barrier, the first fixing portion extending toward an adjacent barrier.

The first fixing portion may further include a support portion, the support portion overlapping an adjacent battery cell and being configured to support the adjacent battery cell.

The second fixing portion may extend along a length direction of the side plate.

The battery module may further include a bottom plate configured to face bottom surfaces of the battery cells, at least one third fixing portion on a bottom surface of the barrier being coupled to at least one fourth fixing portion at the bottom plate.

The third fixing portion may have a shape convex toward the bottom plate, the fourth fixing portion has a shape concave toward the bottom surface of the barrier, and the third fixing portion is accommodated in the fourth fixing portion.

The fourth fixing portion may extend along a length direction of the bottom plate.

The barrier may have a shape corresponding to that of the battery cell.

The barrier may include at least one protruding portion.

A cross-section of the protruding portion may be circular or quadrangular.

The barrier may further include a movable fixing portion overlapping at least a portion of an adjacent battery cell.

A major surface of the movable fixing portion may be perpendicular to a major surface of the barrier, the movable fixing portion protruding toward an adjacent barrier from a top surface of the barrier.

The movable fixing portion may include a cut-away portion exposing a vent in the adjacent battery cell.

### BRIEF DESCRIPTION OF THE DRAWINGS

Features will become apparent to those of ordinary skill in the art by describing in detail exemplary embodiments with reference to the attached drawings, in which:

FIG. 1 illustrates a perspective view schematically showing a battery module according to an embodiment.

FIG. 2 illustrates an exploded perspective view of FIG. 1.

FIG. 3A illustrates a perspective view of a portion of a side plate and a barrier, shown in FIG. 2.

FIG. 3B illustrates a sectional view taken along line A-A′ of FIG. 3A.

FIG. 3C illustrates an enlarged sectional view of region A of FIG. 3B.

FIG. 4A illustrates a perspective view of a portion of a side plate and a barrier in a battery module according to another embodiment.

FIG. 4B illustrates a sectional view taken along line A-A′ of FIG. 4A.

FIG. 4C illustrates an enlarged sectional view of region A of FIG. 4B.

FIG. 5A illustrates a perspective view of a portion of a bottom plate and a barrier in a battery module according to still another embodiment.

FIG. 5B illustrates a sectional view taken along line A-A′ of FIG. 5A.

FIG. 5C illustrates an enlarged sectional view of region A of FIG. 5B.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the example embodiments to those skilled in the art.

In the drawing figures, dimensions may be exaggerated for clarity of illustration. It will be understood that when an element is referred to as being “between” two elements, it can be the only element between the two elements, or one or more intervening elements may also be present. In addition, when an element is referred to as being “on” another element, it can be directly on the other element or be indirectly on the other element with one or more intervening elements interposed therebetween. Also, when an element is referred to as being “connected to” another element, it can be directly connected to the other element or be indirectly connected to the other element with one or more intervening elements interposed therebetween. Like reference numerals refer to like elements throughout.

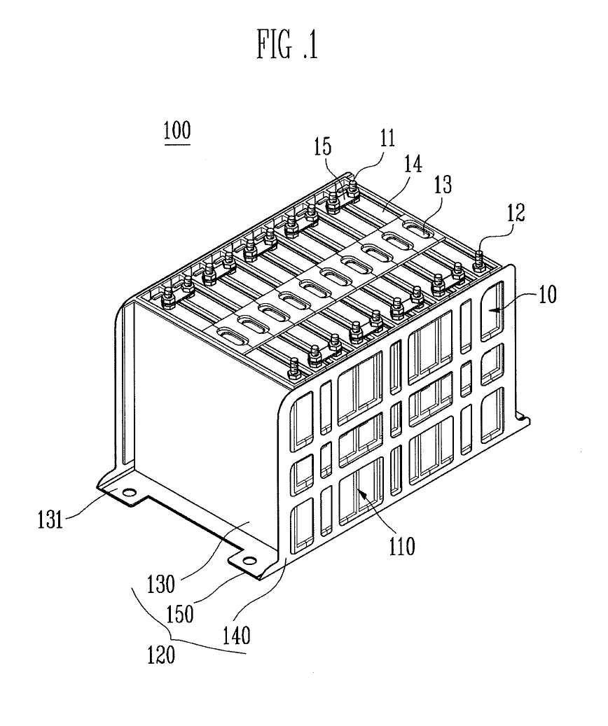

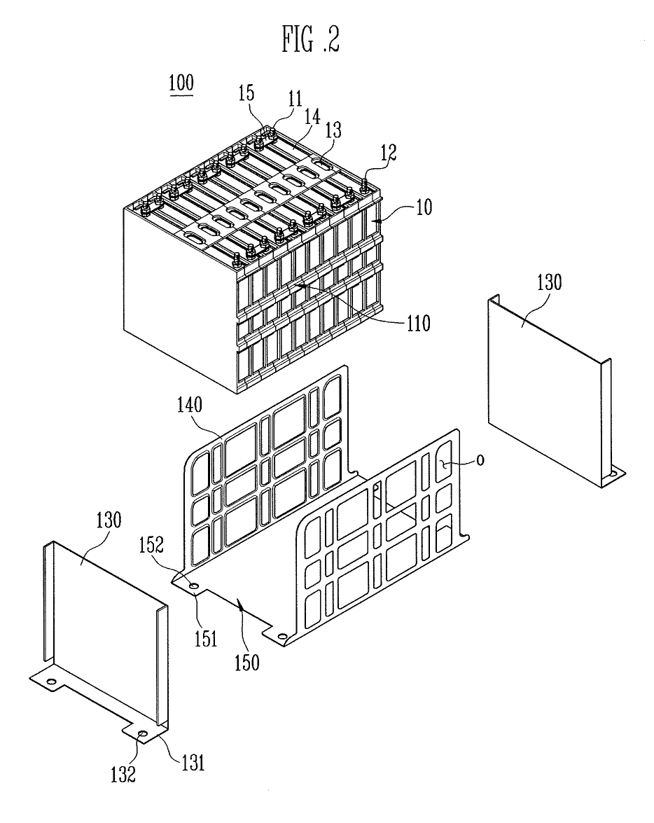

FIG. 1 illustrates a perspective view of a battery module according to an embodiment. FIG. 2 illustrates an exploded perspective view of FIG. 1.

Referring to FIGS. 1 and 2, a battery module 100 according to this embodiment may include a plurality of battery cells 10 aligned in one direction, and each battery cell 10 may have electrode terminals 11 and 12. The battery cells 10 may be aligned so that wide surfaces of adjacent battery cells 10 face each other.

Each of the battery cells 10 constituting the battery module 100 may be manufactured by accommodating an electrode assembly and an electrolyte in a battery case, and then sealing the battery case with a cap plate 14. Here, the electrode assembly includes a positive electrode plate, a negative electrode plate, and a separator interposed between the positive and negative electrode plates. The cap plate 14 may have electrode terminals protruding therethrough to the outside thereof. The electrode terminals include a positive electrode terminal 11 connected to the positive plate and a negative electrode terminal 12 connected to the negative electrode plate. The positive and negative electrode plates may generate electrochemical energy through a reaction with the electrolyte. In this case, the generated energy is transferred to the outside of the battery cell 10 through the positive and negative electrode terminals 11 and 12. A vent 13 may be provided between the positive and negative electrode terminals 11 and 12 to serve as a passage through which gas is exhausted to the outside of the battery cell 10.

In this embodiment, a prismatic lithium ion secondary battery is used as one example of the battery cell 10. However, embodiments are not limited thereto. That is, various types of batteries, e.g., a lithium polymer battery and a cylindrical battery, may be applied to the embodiments.

According to an embodiment, a housing 120 may be configured to include a pair of end plates 130 respectively disposed at outsides of the outermost battery cells 10 among the plurality of battery cells 10. Further, the housing 120 may include a pair of side plates 140 respectively disposed along opposite side surfaces of the battery cell 10 to extend between the pair of end plates 130, and a bottom plate 150 facing a bottom of the battery cell 10.

The plurality of battery cells 10 may be aligned in one direction within a space defined by the pair of end plates 130 and the pair of side plates 140. In this case, the battery cells 10 may be aligned in parallel so that wide front surfaces of the battery cells 10 face each other, and therefore, the positive and negative electrode terminals of two neighboring battery cells 10 may be electrically connected to each other through a bus-bar 15. The bus-bar 15 may be provided with holes through which the positive and negative electrode terminals 11 and 12 may pass. The bus-bar 15 through which the terminals are connected to each other by passing through the respective holes may be fixed by a member such as a nut. The shape or the like of the bus-bar 15 may be freely modified according to the design of the positive and negative electrode terminals 11 and 12.

The end plates 130 come in surface contact with respective outermost battery cells 10, so as to press the plurality of battery cells 10 toward the inside of the plurality of battery cells 10. The end plates 130 may be connected to the side plate 140. For example, any one of the pair of end plates 130 is fastened to one end of the side plate 140, and the other of the pair of end plates 130 is fastened to the other end of the side plate 140. For example, the end plate 130 and the side plate 140 may be fastened to each other through laser welding. In another example, although not shown in FIGS. 1 and 2, fastening holes formed at portions where the end plate 130 and the side plate 140 come in contact with each other may be fastened by a fastening member, e.g., a bolt-nut or a stud.

The side plates 140 may be fastened to the end plates 130, so as to provide a space in which the plurality of battery cells 10 can be aligned and to simultaneously support both side surfaces of the battery cell 10. Although FIG. 2 illustrates that the side plates 140 support both side surfaces of the battery cell 10 and have openings O for refrigerant flow paths, the shape and number of the side plates 140 may be freely modified according to the design of the battery module 100.

The bottom plate 150 may have at least one fastening portion 151 fastened to the end plate 130, and the end plate 130 may have a fastening portion 131 fastened to the fastening portion 151 of the bottom plate 150. The fastening portion 151 of the bottom plate 150 and the fastening portion 131 of the end plate 130 may be fastened to each other, e.g., through laser welding or the like. Alternatively, a fastening hole 152 formed in the fastening portion 151 of the bottom plate 150 and a fastening hole 132 formed in the fastening portion 131 of the end plate 130 may be fastened by a fastening member, e.g., a bolt-nut or a stud.

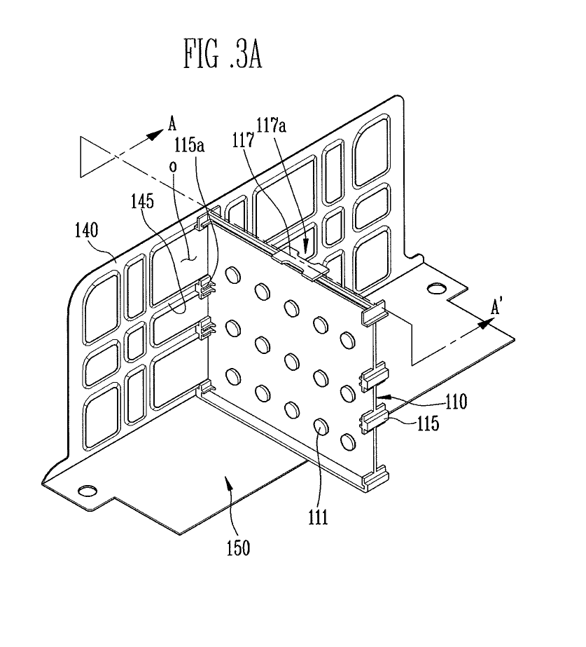

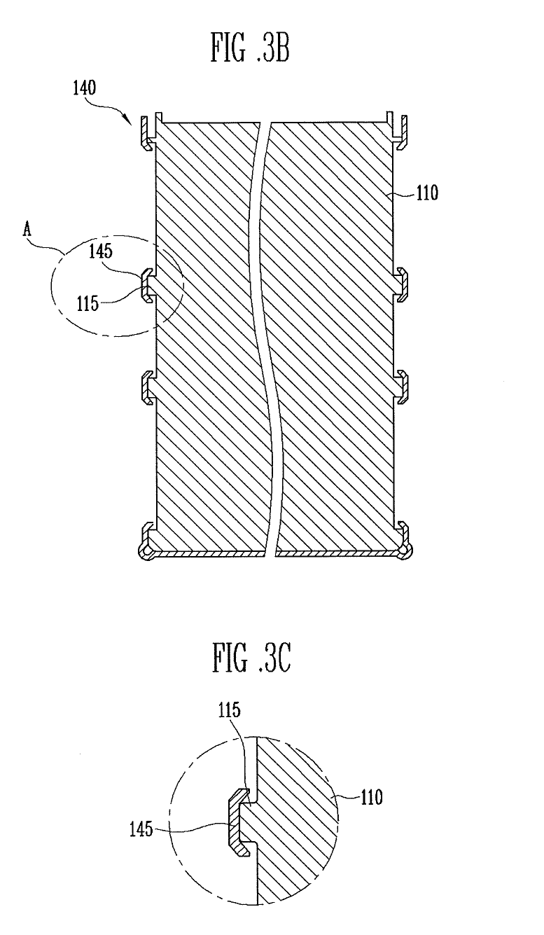

As illustrated in FIG. 2, barriers 110 may be respectively interposed among the plurality of battery cells 10. For example, one barrier 110 may be positioned between every two adjacent battery cells 10. The barrier 110 is provided with a protruding portion 115 (FIG. 3A), so as to allow neighboring battery cells 10 to be spaced apart from each other and to form a space between the neighboring battery cells 10, thereby providing a passage through which a refrigerant for cooling the battery cells 10 can move. Further, the barrier 110 fixes the battery cells 10 to the side plates 140, as will be discussed in more detail below, thereby preventing movement of the battery cells 10, e.g., potential movement caused by an impact applied in a z-axis direction perpendicular to the ground.

FIG. 3A illustrates a perspective view of a portion of the side plate 140 and the barrier 110. FIG. 3B illustrates a sectional view taken along line A-N of FIG. 3A. FIG. 3C illustrates an enlarged sectional view of region A of FIG. 3B.

Referring to FIGS. 3A and 3B, the barrier 110 interposed among the plurality of battery cells 10 may be provided to have a shape corresponding to the battery cell 10. For example, the barrier 110 may overlap an entire surface, i.e., facing the barrier 110, of the battery cell 10.

As illustrated in FIG. 3A, at least one first fixing portion 115 may be formed at a side of the barrier 110, and at least one second fixing portion 145 may be formed at the side plate 140. The second fixing portion 145 of the side plate 140 may be fixed to the first fixing portion 115 of the barrier 110 in order to couple the side plate 140 to the barrier 110.

In detail, the first fixing portion 115 formed at the side of the barrier 110 has a convex shape with respect to the first fixing portion 115, e.g., the first fixing portion may include a protrusion protruding toward the side plate 140. The second fixing portion 145 formed at the side plate 140 has a concave shape with respect to the side plate 140, e.g., the second fixing portion 145 may include a cavity extending away from the barrier 110. In this case, the first fixing portion 115 may be accommodated in the concave shape of the second fixing portion 145, as shown in FIGS. 3B-3C. For example, the first fixing portion 115 and the second fixing portion 145 may have complementary shapes. Thus, the first fixing portion 115 is accommodated in the second fixing portion 145 to improve fastening therebetween, so that it is possible to prevent the barrier 110 from being moved in the vertical direction.

The first fixing portion 115 may be formed perpendicularly to the barrier 110 to protrude toward at least one adjacent barrier 110, e.g., the first fixing portion 115 may protrude toward each of the two adjacent barriers 110. The protruded portion of the first fixing portion 115 faces, e.g., overlaps, a side surface of an adjacent battery cell 10, so that the battery cell 10 is fixed by the protruded portion of the first fixing portion 115, e.g., not to move in the side direction thereof The first fixing portion 115 may further include a support portion 115a that supports the battery cell 10 at a portion facing the battery cell 10 in the protruded portion.

The second fixing portion 145 formed at the side plate 140 may be formed along the length direction of the side plate 140, so as to fix the first fixing portion 115 formed at each barrier 110. In other words, as illustrated in FIG. 3A, the protruded portion of the first fixing portion 115 may be parallel to the second fixing portion 145 and may fit into the cavity of the second fixing portion 145.

The openings O in the side plate 140 for refrigerant flow paths may be formed in at least one of upper and lower portions of the second fixing portion 145 in the side plate 140. For example, as illustrated in FIG. 3A, the second fixing portion 145 may be positioned between two openings O.

According to an embodiment, as further illustrated in FIG. 3A, the barrier 110 may include a movable fixing portion 117 configured to fix at least a portion of the battery cell 10. The movable fixing portion 117 is formed perpendicularly to the barrier 110 to protrude toward at least one adjacent barrier 110 from a top surface of the barrier 110. The protruded portion of the movable fixing portion 117 faces a top surface of an adjacent battery cell 10, so that the battery cell 10 is fixed not to move in the upper direction thereof. A cut-away portion 117a in the movable fixing portion 117 may expose the vent 13 in the adjacent battery cell 10.

As described above, the first fixing portion 115 of the barrier 110 is accommodated in the second fixing portion 145 of the side plate 140, so that the barrier 110 can be fixed not to move in the vertical direction. Thus, the barrier 110 is not easily moved by the impact applied in the z-axis direction perpendicular to the ground. Accordingly, the battery module including the barriers 110 can have a high strength against impact, vibration and distortion in the height direction, applied to the battery module.

A least one protruding portion 111 formed on the barrier 110 may be provided on at least one of first and second surfaces of the barrier 110. The protruding portion 111 is preferably provided on the surface where the barrier 110 and the battery cell 10 come in contact with each other. In this case, a cross-section of the protruding portion 111 may be formed in a circular or quadrangular shape. A number and configuration, e.g., position, of the protruding portions 111 may be variously modified according to the design of the battery module.

The barrier 110 is interposed between neighboring battery cells 10 to allow the battery cells 10 to be spaced apart from each other. Thus, an empty space can be provided between the barrier 110 and the battery cell 10 by the protruding portion 111. The space may serve as a passage through which heat generated in the battery cell 10 is discharged so that the heat is not accumulated, or may become a passage of a refrigerant for cooling the battery cell 10. Further, the barrier 110 may perform a function of pressing the battery cell 10 with a certain pressure or more in order to control swelling of the battery cell 10, e.g., caused in a charging/discharging process of the battery cell 10.

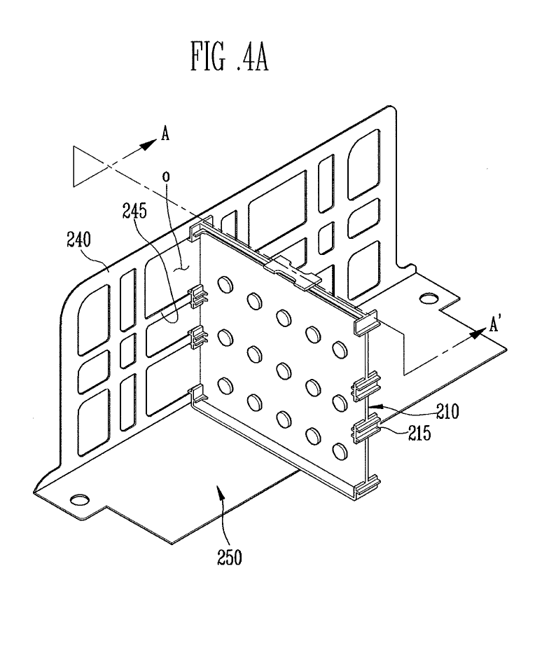

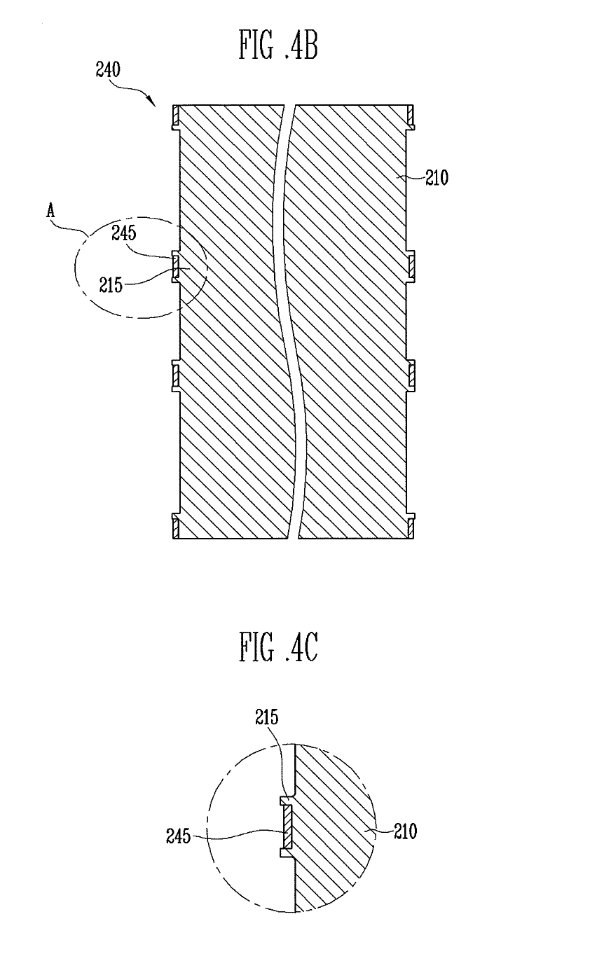

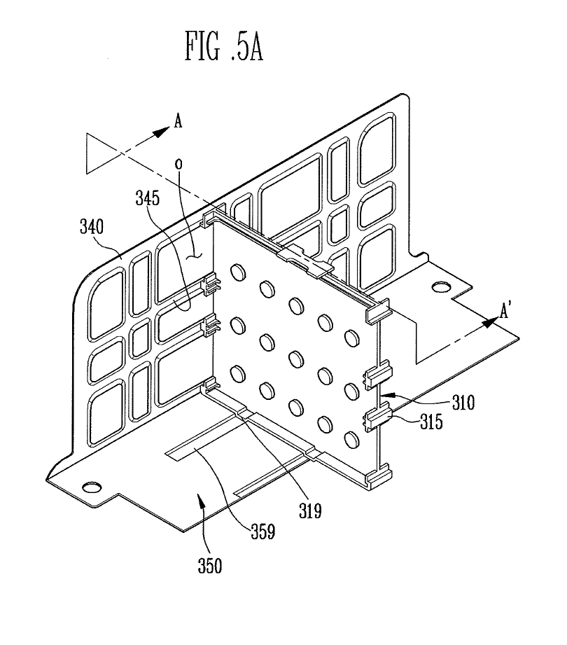

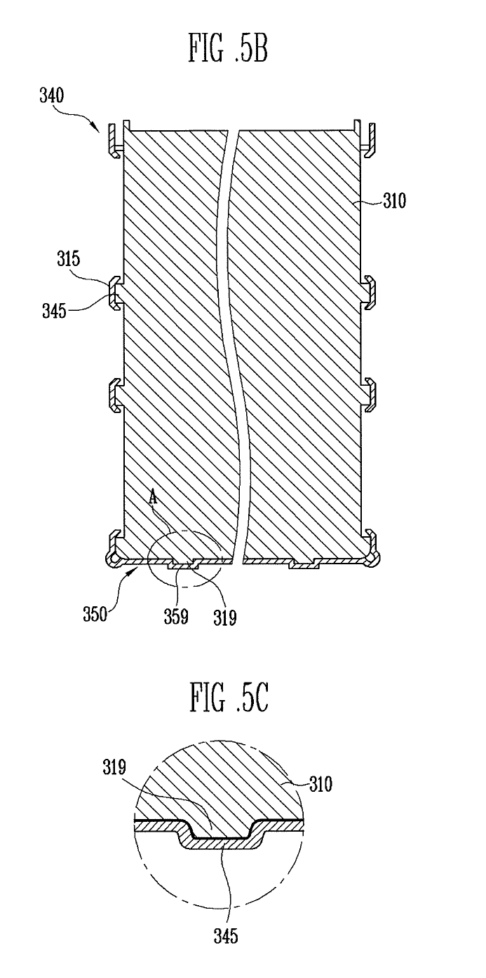

Hereinafter, other embodiments will be described with reference to FIGS. 4A to 5C. Contents of these embodiments, except the following contents, are similar to those of the embodiment described with reference to FIGS. 3A to 3C, and therefore, their detailed descriptions will be omitted.

FIG. 4A illustrates a perspective view of a portion of a side plate and a barrier in a battery module according to another embodiment. FIG. 4B illustrates a sectional view taken along line A-A′ of FIG. 4A. FIG. 4C illustrates an enlarged sectional view of region A of FIG. 4B.

Referring to FIGS. 4A-4C, the battery module according to this embodiment may include the plurality of battery cells 10 aligned in one direction, barriers 210 respectively interposed among the plurality of battery cells 10, and a housing configured to accommodate the battery cells 10 and the barriers 210 therein. The housing is configured to include a pair of end plates, a pair of side plates 240, and a bottom plate 250. The barrier 210 may include at least one first fixing portion 215, and at least one second fixing portion 245 is provided at a position corresponding to that of the first fixing portion 215 in the side plate 240.

The first fixing portion 215 is formed on a side of the barrier 210, and may have a rotated “π” shape. For example, as illustrated in FIG. 4B, the first fixing portion 215 may include two parallel protrusions spaced apart from each other along a vertical direction and extending toward the side pate 240.

As illustrated in FIG. 4A, the side plate 240 may include the second fixing portion 245 between openings O adjacent to each other along a vertical direction, i.e., a direction normal to the bottom plate 250, so a predetermined width of the second fixing portion 245 along the vertical direction may be defined by the vertical distance between the adjacent openings O. The second fixing portion 245 is fixed to the first fixing portion 215 by being accommodated in the “π” shape of the first fixing portion 215 as shown in FIG. 4C, e.g., the fixing portion 245 may fit between the two protrusions of the first fixing portion 215. Thus, it is possible to prevent the barrier 210 from being moved in the vertical direction. Accordingly, the battery module including the barriers 210 may have high strength against impact, vibrations, and distortion in the height direction, e.g., potentially applied to the battery module.

FIG. 5A illustrates a perspective view of a portion of a bottom plate and a barrier in a battery module according to still another embodiment. FIG. 5B illustrates a sectional view taken along line A-A′ of FIG. 5A. FIG. 5C illustrates an enlarged sectional view of region A of FIG. 5B.

Referring to FIGS. 5A-5C, the battery module according to this embodiment may include the plurality of battery cells 10 aligned in one direction, barriers 310 respectively interposed between the plurality of battery cells 10, and a hosing configured to accommodate the battery cells 10 and the barriers 310 therein. The housing is configured to include a pair of end plates, a pair of side plates 340, and a bottom plate 350. The barrier 310 may include at least one first fixing portion 315 and at least one third fixing portion 319. Further, at least one second fixing portion 345 is provided at a position corresponding to that of the first fixing portion 315 in the side plate 340, and at least one fourth fixing portion 359 is provided at a position corresponding to that of the third fixing portion 319 in the bottom plate 350. The first and second fixing portions 315 and 345 may be substantially the same as the first and second fixing portions 115 and 145 in FIGS. 3A-3C.

In detail, referring to FIGS. 5A to 5C, the third fixing portion 319 formed on a bottom surface of the barrier 310 has a shape convex toward the bottom plate 350, and the fourth fixing portion 359 formed at the bottom plate 350 has a shape concave toward the bottom surface of the barrier 310. In this case, the third fixing portion 319 is accommodated in the concave shape of the fourth fixing portion 359. As the third fixing portion 319 is accommodated in the fourth fixing portion 359, it is possible to prevent the barrier 310 from being moved in the width direction of the barrier 310. According to an embodiment, the fourth fixing portion 359 formed at the bottom plate 350 is formed along the length direction of the bottom plate 350, so as to fix the third fixing portion 319 formed at each barrier 310.

As described above, according to embodiments, the barriers 110, 210, and 310 disposed among the battery cells 10 and respective side plates 140, 240 or 340 and/or bottom plates 150, 250, and 350 are fixed to one another, so that the battery cells 10 constituting the battery module can be firmly fixed, regardless of impact applied in any direction. Accordingly, it is possible to improve the impact resistance of the battery module.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A battery module, comprising:
a plurality of battery cells aligned in one direction, the plurality of battery cells being adjacent to each other along a first direction;
a pair of side plates spaced apart from each other along a second direction perpendicular to the first direction, the plurality of aligned battery cells being positioned between the pair of side plates; and
barriers respectively interposed among the plurality of battery cells, each barrier including at least one first fixing portion on a side thereof, the at least one first fixing portion being coupled to a corresponding second fixing portion on a side plate of the pair of side plates.

2. The battery module as claimed in claim 1, wherein the first fixing portion includes a protrusion extending toward the side plate.

3. The battery module as claimed in claim 2, wherein the protrusion has a convex shape extending toward the side plate.

4. The battery module as claimed in claim 3, wherein the second fixing portion has a concave shape extending away from the barrier, the convex shape being accommodated in the concave shape of the second fixing portion.

5. The battery module as claimed in claim 2, wherein the first protrusion has a “π” shape.

6. The battery module as claimed in claim 5, wherein the second fixing portion is between openings in the side plate, a width of the second fixing portion being equal to a distance between the openings and being accommodated in the π-shape.

7. The battery module as claimed in claim 2, wherein a longitudinal direction of the first fixing portion is perpendicular to the barrier, the first fixing portion extending toward an adjacent barrier.

8. The battery module as claimed in claim 7, wherein the first fixing portion further comprises a support portion, the support portion overlapping an adjacent battery cell and being configured to support the adjacent battery cell.

9. The battery module as claimed in claim 2, wherein the second fixing portion extends along a length direction of the side plate.

10. The battery module as claimed in claim 1, further comprising a bottom plate configured to face bottom surfaces of the battery cells, at least one third fixing portion on a bottom surface of the barrier being coupled to at least one fourth fixing portion at the bottom plate.

11. The battery module as claimed in claim 10, wherein the third fixing portion has a shape convex toward the bottom plate, the fourth fixing portion has a shape concave toward the bottom surface of the barrier, and the third fixing portion is accommodated in the fourth fixing portion.

12. The battery module as claimed in claim 11, wherein the fourth fixing portion extends along a length direction of the bottom plate.

13. The battery module as claimed in claim 1, wherein the barrier has a shape corresponding to that of the battery cell.

14. The battery module as claimed in claim 1, wherein the barrier includes at least one protruding portion.

15. The battery module as claimed in claim 14, wherein a cross-section of the protruding portion is circular or quadrangular.

16. The battery module as claimed in claim 1, wherein the barrier further comprises a movable fixing portion overlapping at least a portion of an adjacent battery cell.

17. The battery module as claimed in claim 16, wherein a major surface of the movable fixing portion is perpendicular to a major surface of the barrier, the movable fixing portion protruding toward an adjacent barrier from a top surface of the barrier.

18. The battery module as claimed in claim 16, wherein the movable fixing portion includes a cut-away portion exposing a vent in the adjacent battery cell.
